(19) United States
(12) Patent Application Publication
(10) Pub. No.: US 2007/0276950 A1
(43) Pub. Date: Nov. 29, 2007

(54) Firewall For Dynamically Activated Resources

(76) Inventor: Rajesh Dadhia, Redmond, WA (US)

Correspondence Address: PERKINS COIE LLP/MSFT, P. O. BOX 1247, SEATTLE, WA, 98111-1247, US

(21) Appl. No.: 11/420,672

(22) Filed: May 26, 2006

(51) Int. Cl. G06F 15/173; G06F 15/16

(52) U.S. Cl. 709/229; 709/225

(57) ABSTRACT

A facility is described for providing a firewall for dynamically activated resources. In various embodiments, the facility registers a component for processing a message. The registration includes storing a unique identifier associated with the component. When the facility receives a message, it determines whether the message contains a unique identifier and, if so, identifies a component for processing the message based on the identifier and forwards the message to the identified component.

### BACKGROUND

A firewall is hardware or software that enforces security policies by using one or more filters that can disallow unauthorized or potentially dangerous material from entering the computing environment with which the firewall is used. Firewalls can also restrict access to an operating system's resources, such as files, network ports, storage, and so forth. Firewalls generally enable administrators to specify filters to prevent or enable operation of specified software applications, ranges of Transport Control Protocol/Internet Protocol (“TCP/IP”) ports, types or contents of network messages, and so forth. Firewalls can be designed for use with specific operating systems. An example of a firewall for use with the MICROSOFT WINDOWS operating system is MICROSOFT WINDOWS FIREWALL.

Administrators configure firewalls by manipulating various settings, such as by specifying which TCP/IP ports should be open and which should be closed. However, these settings do not capture various scenarios of attacks on the operating system by malicious software (“malware”), such as viruses, worms, and Trojan horses. As an example, conventional firewall software prevents or enables all remote procedure calls (“RPCs”). RPC is a protocol that enables software components to communicate with other components. The RPC protocol facilitates inter-process communication by enabling a program running on one computer to execute code on the same or another computer. RPCs can also be used by malware to cause an operating system or other system component to perform undesirable functions. As an example, malware may use RPCs to delete or steal data. When a firewall enables all RPC traffic, the “attack surface” is said to be large because malware can use any RPC interface, endpoint, or other port. In such a case, malware could use the RPC mechanism to attack an operating system. On the other hand, when a firewall disables all RPC traffic, desirable software may be prevented from functioning properly or completing their intended tasks.

Aspects of RPCs and DCOM are examples of dynamically activated resources. Applications and operating system services sometimes use these and other dynamically activated resources to complete various tasks. Another example of a dynamically activated resource is a TCP/IP port that is created dynamically. While TCP/IP ports can be “well known” (e.g., port 80 for hypertext transfer protocol (“HTTP”), port 25 for simple mail transfer protocol (“SMTP”), and so forth), they are sometimes dynamically activated and used to enable RPCs, provide distributed component object model (“DCOM”) services, and so forth. By using a TCP/IP port that an RPC server dynamically activates or allocates for itself, the RPC server can “listen” for requests from an RPC client. The RPC client can invoke an RPC method by sending an RPC message to the dynamically allocated or activated port. Another example of a dynamically activated resource is a DCOM server. DCOM provides a protocol that enables a component object model (“COM”) client to use RPCs to communicate with a DCOM server. When a DCOM client requests a service from a DCOM server, the operating system may dynamically activate a DCOM server to provide the requested service.

Administrators of operating systems sometimes desire to prevent undesirable software from executing. As an example, administrators may desire to prevent games from executing on computing systems belonging to an employer. As another example, administrators desire to prevent malware from executing. However, the administrator may need to enable desirable software, such as business-related software. The undesirable and desirable software may both use resources that are dynamically allocated, such as RPCs. If the administrator sets a filter to prevent use of RPCs, the undesirable software is prevented from functioning, but so is desirable software. If, on the other hand, the administrator sets the filter to enable use of RPCs, both the desirable and undesirable software are operable.

### SUMMARY

A facility is described that provides a firewall for dynamically activated resources. The facility provides an application programming interface that enables applications, services, and other components to register themselves as providers of dynamically activated resources, such as RPC services. During the registration, each component provides an identifying name and a unique identifier. The unique identifier is associated with one or more interfaces provided by these service applications, services, and other components. An administrator can then employ a user interface provided by the facility to configure the facility to enable one or more of the registered components yet disable other registered components and unregistered components. When a message arrives, the facility can determine whether the message should be filtered based on whether the message contains a unique identifier of a component that has been indicated as enabled. Thus, an administrator can disable all dynamic activation of resources by default, but enable specified exceptions to this general rule.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram illustrating an environment in which the facility operates in some embodiments.

FIGS. 2 and 3 are block diagrams illustrating some components associated with the facility in various embodiments.

FIG. 4 is a table diagram illustrating a universally unique identifier table employed by the facility in some embodiments.

FIGS. 5 and 6 are display diagrams illustrating aspects of user interfaces associated with the facility in various embodiments.

FIG. 7 is a flow diagram illustrating a register routine invoked by the facility in some embodiments.

FIG. 8 is a flow diagram illustrating an add_exception routine invoked by the facility in some embodiments.

FIG. 9 is a flow diagram illustrating a map_endpoint routine invoked by the facility in some embodiments.

### DETAILED DESCRIPTION

A facility is described that provides a firewall for dynamically activated resources. Examples of dynamically activated resources include, e.g., dynamically created ports, dynamically activated DCOM components, and so forth. In various embodiments, the facility provides an application programming interface (“API”) that enables applications, services, and other components to register themselves as providers of dynamically activated resources, such as RPC services. During the registration, each component provides an identifying name and a unique identifier, such as a universally unique identifier (“UUID”). As examples, an RPC service may provide a unique identifier and a DCOM component may provide a DCOM Application ID. The UUID is associated with one or more interfaces provided by the service providers. An administrator can then employ a user interface (“UI”) provided by the facility to configure the facility to enable one or more of the registered components yet disable other registered components as well as unregistered components. When a component is enabled, the facility does not filter out network traffic relating to that component. In contrast, when a component is disabled, the facility filters out network traffic relating to that component. The facility may be configured to apply a general filter rule, such as to prevent all RPC messages. When a registered component is enabled, an indication is added to a list of exceptions to the general filter rule. As an example, an exception to enable RPC messages having a particular UUID is added to the general filter rule of disabling all RPC messages. When a computing environment (e.g., operating system or hardware device) receives a message, an associated firewall determines whether the message is of a type that is to be generally filtered (e.g., RPC messages). If it is to be generally filtered, the firewall next requests the facility to determine whether the incoming message contains a UUID. If the incoming message contains a UUID that has been registered and is associated with an enabled component, the facility forwards the message to its destination. If the incoming message does not contain a UUID or contains a UUID that does not correspond to an enabled component, the message is filtered out.

In various embodiments, the facility receives the message at a known resource and determines a dynamically activated resource that should receive the message. This can be referred to as mapping an endpoint for the message. As an example, the facility may provide a “well-known” TCP/IP port at which it receives an initial RPC message destined to an enabled service provider, such as TCP/IP port 135. This port number is identified as “well known” because client components corresponding to the registered service provider may be programmed to transmit initial (or all) messages to this well-known port. Upon receiving the initial message at the well-known port, the facility determines whether a UUID indicated by the message corresponds to an enabled component. If that is the case, the facility determines an actual port number that the corresponding component employs to receive messages. The facility can forward the received message to the determined port number. The facility may also communicate the determined port number to the client component that sent the initial message so that the client component can send a message to the determined port number. In various embodiments, the client component may send subsequent messages either to the well-known port or to the determined port number. When subsequent messages are received by the facility at the well-known port, the facility can forward the received messages to the determined port number.

In various embodiments, the facility can be used to enable or disable identified RPC interfaces or methods provided by a component instead of all RPC interfaces or methods provided by the component. The facility can enable identified RPC interfaces or methods by associating a UUID with each such interface or method and then selectively forwarding only messages containing enabled UUIDs. Thus, a subset of interfaces or methods provided by a component can be enabled or disabled by an administrator.

In various embodiments, the facility can be employed to selectively enable DCOM components. A DCOM message generally contains a globally unique identifier (“GUID”). A GUID generally corresponds to multiple UUIDs. By enabling the multiple UUIDs corresponding to a GUID, the facility can be used to enable some DCOM components but disable others.

Thus, the facility enables an administrator to reduce the attack surface available to malware by selectively enabling dynamically activated resources. Instead of enabling all RPCs, for example, the administrator can selectively enable some of them.

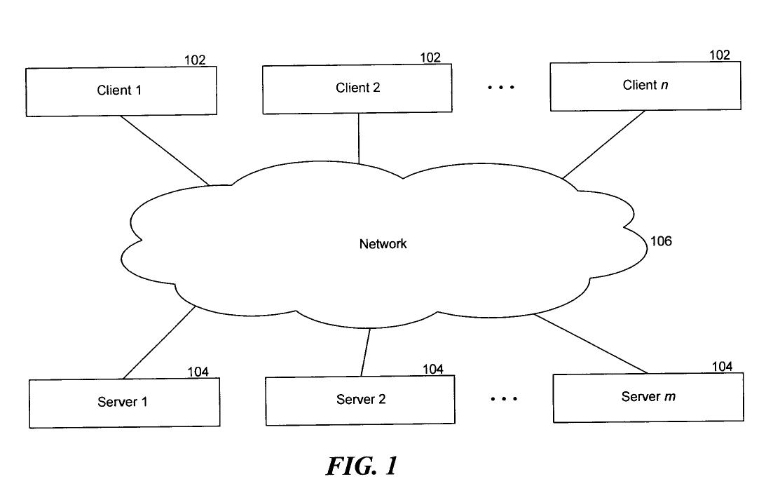

Turning now to the figures, FIG. 1 is a block diagram illustrating an environment in which the facility operates in some embodiments. One or more client computing devices 102 are interconnected with one or more server computing devices 104 via a network 106, such as an intranet or the Internet.

Client and server computing devices can be various types of general purpose or specifically configured computers. Components of the computers may include, but are not limited to, a processing unit, a system primary memory, a storage device, a network adapter or interface, a display, and one or more input and output devices. A computer typically includes a variety of computer-readable media that are operable with the storage device. Computer-readable media can be any available media that can be accessed by the computer and include both volatile and nonvolatile media and removable and nonremovable media.

The computer may operate in a networked environment using logical connections to one or more remote computers. A remote computer may be a personal computer, a server, a router, a network PC, a peer device, or other common network node, and typically includes many or all of the elements described above in relation to the computer. A logical connection can be made via a local area network (LAN) or a wide area network (WAN), but may also include other networks. Such networking environments are commonplace in homes, offices, enterprise-wide computer networks, intranets, and the Internet. The computer can be connected to a network through a network interface or adapter, such as to a wired or wireless network.

The computer is only one example of a suitable computing environment and is not intended to suggest any limitation as to the scope of use or functionality of the facility. The computing system should not be interpreted as having any dependency or requirement relating to any one or a combination of the illustrated components.

The facility is operational with numerous other general purpose or special purpose computing systems or configurations. Examples of well-known computing systems, environments, and/or configurations that may be suitable for use with the facility include, but are not limited to, personal computers, server computers, handheld or laptop devices, cellular telephones, tablet devices, multiprocessor systems, microprocessor-based systems, set-top boxes, programmable consumer electronics, network PCs, minicomputers, mainframe computers, distributed computing environments that include any of the above systems or devices, and the like.

The facility may be described in the general context of computer-executable instructions, such as program modules, that are executed by a computer. Generally, program modules include routines, programs, objects, components, data structures, and so forth that perform particular tasks or implement particular abstract data types. The facility may also be employed in distributed computing environments where tasks are performed by remote processing devices that are linked through a communications network. In a distributed computing environment, program modules may be located in local and/or remote computer storage media, including memory storage devices.

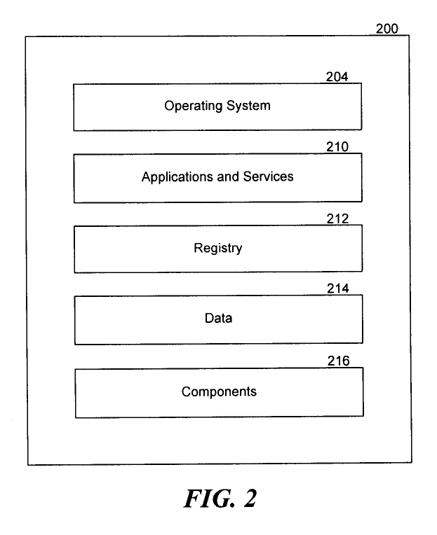

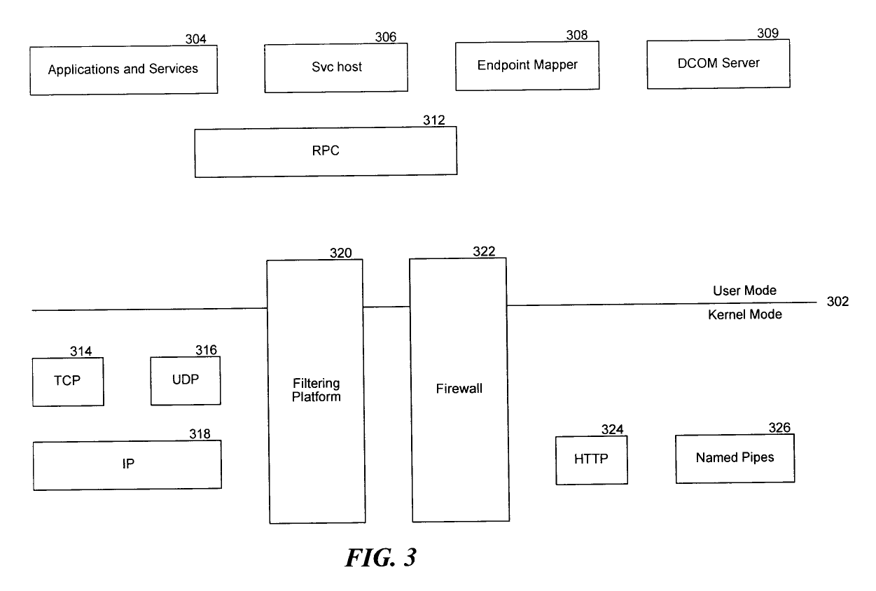

FIGS. 2 and 3 are block diagrams illustrating some components associated with the facility in various embodiments.

FIG. 2 is a block diagram illustrating a computer in further detail in some embodiments. The computer 200 includes an operating system 204, applications and services 210, registry 212, data 214, and components 216. The operating system can be any operating system compatible with the computer, such as MICROSOFT WINDOWS, LINUX, MAC OS, and so forth. The operating system may also include a firewall. The firewall may be an operating system component or may be a separate component, such as an application or service. Applications and services are clients and service provider components that employ or activate resources dynamically. The clients and service provider components can be on the same or on separate computing devices. An example of a client is an application that invokes an RPC interface of a server to retrieve information available on a database server. An example of a service provider component is a component that provides an RPC interface for clients to request data from the database server. The registry stores registration information, such as correspondences between component names and UUID numbers. The registry can also store indications of enabled or disabled components, UUIDs, and so forth. The registry can be stored in an operating system registry, database, file, memory, etc. The facility may store or retrieve other data, such as data that may be needed to authenticate messages, filter messages, and so forth. The facility may operate with other components, such as components that provide ancillary services associated with the facility.

FIG. 3 is a block diagram illustrating components associated with the facility in various embodiments. Some components operate in user mode, and are illustrated above line 302. These are applications and services 304, a service host (“svc host”) component 306, endpoint mapper 308, DCOM server 309, and RPC component 312. Applications and services were described above in relation to FIG. 2. The service host is a component that generally hosts services, such as RPC services. When conventional firewalls disable RPC messages, they generally also disable the service host, and so even desirable RPC messages are filtered out. In contrast, the facility does not filter out desirable RPC messages, and so may not disable the service host. The endpoint mapper forwards messages that arrive at a well known TCP/IP port to a TCP/IP port corresponding to a service (e.g., RPC service) that should process the arriving messages. The DCOM server is a DCOM service provider. The applications, services, and service host may employ the RPC component to process RPC messages.

Other components operate in kernel mode, and are illustrated below line 302. TCP driver 314 and UDP driver 316 operate with IP driver 318 to process TCP/IP and UDP over IP messages. HTTP driver 324 processes HTTP messages. A named pipes component 326 processes named pipes, which enable two processes that are executing on the same or different computers to communicate with each other. RPCs can employ named pipes and HTTP to send and receive information.

Filtering platform 320 and firewall 322 operate in both user mode and kernel mode, and are illustrated in FIG. 3 as having portions on both sides of line 302. The filtering platform provides filtering services associated with the operating system. The filtering platform may also provide the API associated with the facility. Other components, whether operating in user mode or kernel mode, can access methods, properties, and other aspects of the facility's API. The firewall can be a third-party component that provides additional filtering services. As an example, even though the facility does not filter out an RPC message identifying a particular UUID, the third-party firewall component may filter out the RPC message if it determines, e.g., based on the message's contents, that the message is undesirable.

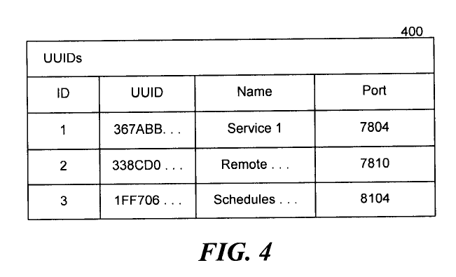

FIG. 4 is a table diagram illustrating a UUID table employed by the facility in some embodiments. The facility can employ the table 400 to store relationships between names of components, UUIDs, ports, and so forth. The facility can employ the table when components register, when the facility needs to determine whether a component has registered a port for a UUID, etc. The table may additionally indicate which UUIDs are enabled (not illustrated), such as by employing a true/false column (not shown). Alternatively, a list of enabled and disabled UUIDs may be stored separately.

While FIG. 4 and its related description show a table whose contents and organization are designed to make them more comprehensible by a human reader, those skilled in the art will appreciate that actual data structures used by the facility to store this information may differ from the table shown, in that they, for example, may be organized in a different manner, may contain more or less information than shown, may be compressed and/or encrypted, etc.

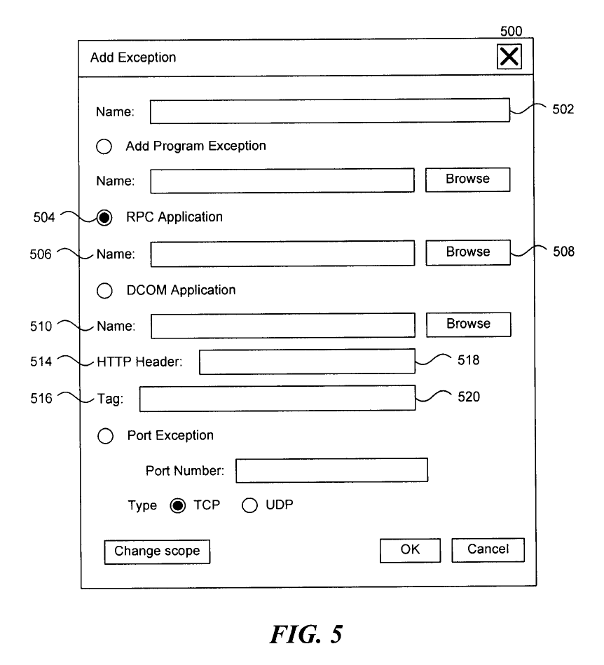

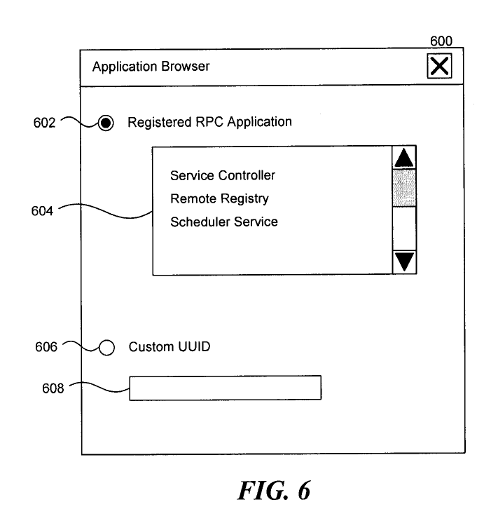

FIGS. 5 and 6 are display diagrams illustrating aspects of user interfaces associated with the facility in various embodiments.

FIG. 5 illustrates a user interface for adding an exception to a general rule. The UI 500 can be employed to add exceptions to general rules denying all RPC messages, as an example. An edit region 502 enables the user to specify a name for the exception. A radio button region 504 enables the user to indicate that the exception relates to an RPC application. The user can specify a name 506 for the application by selecting a browse pushbutton region 508 and then selecting an application or component. The user could similarly have selected a DCOM application, whose name would appear in edit region 510. The user can additionally indicate filters based on contents of messages, such as contents of a message's HTTP header, by specifying a header field name 514 (in edit region 518) and its contents or tag 516 (in edit region 520). In various embodiments, the HTTP header and tag regions can also relate to the RPC application described above. The HTTP header's contents could be checked for a particular UUID, for example, such as when HTTP is used to exchange messages containing RPCs. Alternatively, the HTTP header could be checked for other identifiers or attributes indicating that the message should not be filtered out.

In various embodiments, the facility can use TCP/IP to transport RPC messages in lieu of (or in addition to) HTTP messages. In such a case the facility can place the UUID inside the TCP/IP messages.

FIG. 6 illustrates a user interface for registering UUIDs that should be enabled. The UI 600 may appear when the user selects pushbutton 508 of FIG. 5. The user can select a registered RPC application by selecting radio button region 602 and then selecting one or more applications listed in list region 604, or can select radio button region 606 and type in one or more UUID numbers in edit region 608. The entered or selected information would then appear in the UI illustrated in FIG. 5.

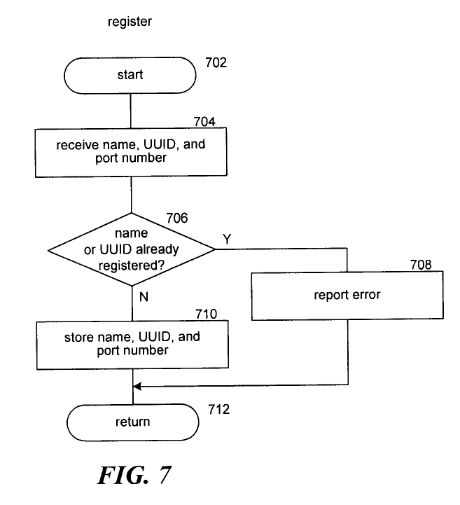

FIG. 7 is a flow diagram illustrating a register routine invoked by the facility in some embodiments. The facility invokes the register routine to register correspondences between UUIDs and components. In various embodiments, the facility invokes the routine during startup or when a component (e.g., RPC service component) is first installed. The routine begins at block 702.

At block 704, the routine receives a name of the component that is to be registered, one or more UUIDs associated with the component, and a port number at which the component will listen for messages. The name of the component can be a human-readable name that is used in a UI associated with the facility to identify a component. The received UUIDs correspond to the UUIDs associated with the identified component that identify messages that should not be filtered out when the component is enabled. The received port number is the TCP/IP port at which the component will receive messages. The endpoint mapper may forward messages it receives at a well known port to the identified TCP/IP port number.

In various embodiments, the component does not register the port number when it is registered. Instead, the component may register the port number when it starts, such as after the computer is rebooted.

At block 706, the routine determines whether the received name or UUID is already registered. If the received name or UUID is already registered, the routine continues at block 708. Otherwise, the routine continues at block 710.

At block 708, the routine reports an error to the user and then continues at block 712, where it returns.

At block 710, the routine stores the received name, UUIDs, and port number. As an example, the routine may store the received information in a UUID table, such as in a registry or other storage. The routine then continues at block 712, where it returns.

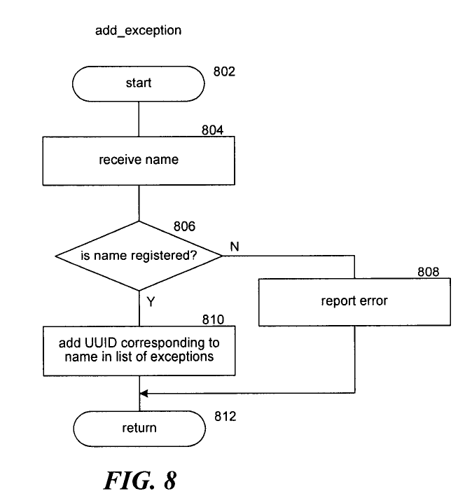

FIG. 8 is a flow diagram illustrating an add_exception routine invoked by the facility in some embodiments. The facility invokes the add_exception routine to add an exception to a general rule. As an example, the facility invokes the add_exception routine to indicate that a particular RPC server component is to be enabled even though RPC is generally disabled. The routine begins at block 802.

At block 804, the routine receives a name of a component. The name can be the name indicated in the UUID table, and may be provided in the UI described above.

At block 806, the routine determines whether the received name is registered. The routine may make this determination by evaluating the received name against the UUID table. If the received name is registered, the routine continues at block 810. Otherwise, the routine continues at block 808.

At block 808, the routine may report an error to the user. As an example, the routine may indicate that the received name does not correspond to a registered component. The routine then continues at block 812, where it returns.

At block 810, the routine adds the UUID corresponding to the received name to a list of exceptions. Then, when the facility receives a message that is indicated to be forwarded to the component by specifying the component's UUID, the facility will not filter out the message. On the other hand, when the facility receives a message that does not correspond to an enabled component's UUID, the facility filters out the message.

Although the illustrated routine is described in terms of receiving an indication of a component name, the routine could equally receive one or more UUIDs to add to the exceptions list. In such a case, the routine would instead determine whether the UUID corresponds to an enabled component and add the UUID to the exceptions list if that is the case. Thus, even when a component is enabled, only a subset of its UUIDs may be enabled and so only messages containing the UUIDs listed in the exceptions list would be forwarded.

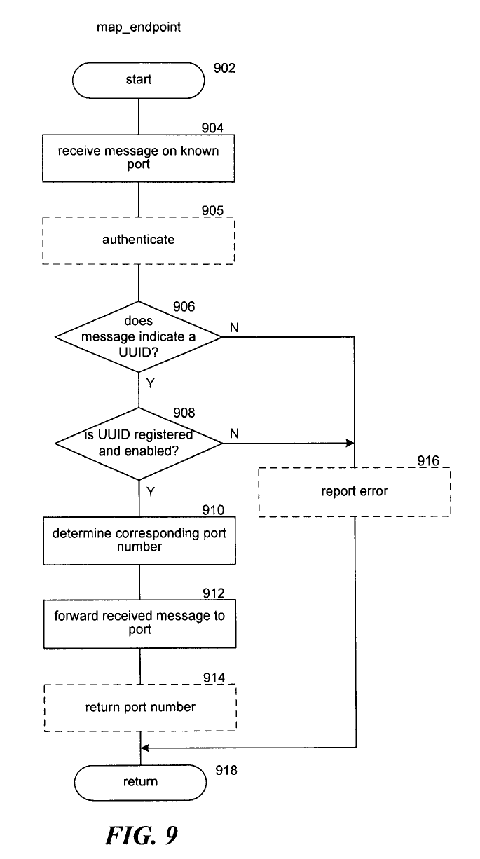

FIG. 9 is a flow diagram illustrating a map_endpoint routine invoked by the facility in some embodiments. The facility invokes the map_endpoint routine to map an endpoint (e.g., target) for a message that arrives at a well known port. The routine begins at block 902.

At block 904, the routine receives a message at a well known port. As an example, the routine may receive the message at TCP/IP port 135.

At block 905, the routine optionally authenticates the received message. As an example, the routine may determine whether messages from a particular TCP/IP address or range of addresses are to be accepted or ignored. Alternatively, the routine may determine whether a destination TCP/IP address or range of addresses indicated in the received message is valid.

At block 906, the routine determines whether the message indicates a UUID. When the message indicates a UUID, the routine continues at block 908. Otherwise, the routine continues at block 916.

At block 908, the routine determines whether the indicated UUID is registered and enabled. If the indicated UUID is registered and enabled, the routine continues at block 910. Otherwise, the routine continues at block 916.

At block 910, the routine determines the port number corresponding to the indicated UUID. As an example, the routine may determine the correspondence by evaluating the UUID table.

At block 912, the routine forwards the received message to the determined TCP/IP port. The service provider can then process the message.

At block 914, the routine optionally returns the determined TCP/IP port number to the client component that sent the message so that the client component can send subsequent messages directly to the determined TCP/IP port number. The routine then continues at block 918, where it returns.

At block 916, the routine optionally reports an error to the user. The routine then continues at block 918, where it returns.

Those skilled in the art will appreciate that the steps shown in FIGS. 7-9 and in their corresponding descriptions may be altered in various ways. For example, the order of the logic may be rearranged, substeps may be performed in parallel, illustrated logic may be omitted, additional logic may be included, etc.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I claim:

1. A method performed by a computer system for providing a firewall for dynamically activated resources, comprising:
receiving an indication to register a component that processes messages associated with a dynamically activated resource, the indication including a unique identifier associated with the component;
receiving a message;
determining whether the received message contains the unique identifier;
when the received message contains the unique identifier, determining whether the identified component having the unique identifier is enabled; and
when the identified component having the unique identifier is enabled, forwarding the received message to the identified component having the unique identifier; and
when the identified component having the unique identifier is disabled, filtering out the message.

2. The method of claim 1 wherein the received message contains a remote procedure call.

3. The method of claim 1 wherein the received message is from a distributed component object model component.

4. The method of claim 1 wherein the determining includes analyzing contents of the received message.

5. The method of claim 1 wherein the identifying includes looking for the identifier contained in the message in a table providing correspondences between identifiers and registered components.

6. The method of claim 1 further comprising receiving from a user an indication that the component is to be enabled, the indication identifying a name associated with the component, the name appearing in a human-readable form.

7. The method of claim 1 wherein the message is received at a well known port.

8. The method of claim 1 wherein the message is forwarded to the component at a port different from a port at which the message was received.

9. A computer-readable medium having computer-executable instructions that, when executed, cause a computer system to perform a method of providing a firewall for dynamically activated resources, the method comprising:
registering a component that processes messages associated with a dynamically activated resource, the registering including storing a unique identifier associated with the component;
receiving a message;
determining whether the received message contains the unique identifier; and
identifying the component for processing the message based on the received identifier.

10. The computer-readable medium of claim 9 further comprising forwarding the received message to the identified component when the identified component is enabled.

11. The computer-readable medium of claim 9 wherein the registering includes storing the received information so that when a message arrives, a component for handling the message can be determined based on a unique identifier indicated by the message.

12. The computer-readable medium of claim 9 wherein the unique identifier identifies an interface provided by the registered component.

13. The computer-readable medium of claim 12 wherein the registered component has multiple interfaces.

14. The computer-readable medium of claim 13 wherein some of the interfaces are not enabled.

15. The computer-readable medium of claim 14 wherein when the message identifies a unique identifier associated with an interface that is not enabled, the message is filtered out.

16. A system for providing a firewall for dynamically activated resources, comprising:
an endpoint mapper that receives a message at a well known port, determines whether the message identifies a registered and enabled component that receives messages at another port, and forwards the received message to the other port; and
a filtering component that, upon receiving a message, determines whether the received message identifies the registered and enabled component, and causes the endpoint mapper to forward the received message to the identified component.

17. The system of claim 16 wherein the message identifies a component by specifying a universally unique identifier.

18. The system of claim 16 wherein the endpoint mapper provides the message to the filtering component.

19. The system of claim 18 wherein the message contains a remote procedure call and the filtering component determines whether the message identifies a unique identifier that appears in a list of exceptions to a general rule that filters out all messages containing remote procedure calls.

20. The system of claim 16 further comprising a client component that sends a message to the well known port wherein the identified component is a service provider component that receives and processes the sent message.
